(19) United States
(12) Patent Application Publication
(10) Pub. No.: US 2010/0082563 A1
(43) Pub. Date: Apr. 1, 2010

(54) SYSTEM IMPACT SEARCH ENGINE

(75) Inventors: Oliver Augenstein, Schoonbuch (DE); Joerg Erdmenger, Waldenbuch (DE); Martin Raitza, Boeblingen (DE)

Correspondence Address: McGinn Intellectual Property Law Group, PLLC, 8321 Old Courthouse Road, Suite 200, Vienna, VA, 22182-3817, US

(73) Assignee: International Business Machines Corporation, Armonk, NY (US)

(21) Appl. No.: 12/241,923

(22) Filed: Sep. 30, 2008

(51) Int. Cl. G06F 17/30

(52) U.S. Cl. 707/705; 707/E17.014

(57) ABSTRACT

A method of applying a tag cloud to systems management resources to visualize components which are related to an event includes automatically creating initial tags for information technology (IT) resources in an enterprise system or data center based on usage or access information, specifying, in a user interface, a specific resource in the tag cloud to search, using the resource to provide a reverse search of initiators of the resource to obtain business impact of the resource, and automatically presenting search results of the initiators in a new tag cloud in a ranking order representing an amount of the usage or access information.

### BACKGROUND OF THE INVENTION

1. Field of the Invention

The present invention generally relates to a method and system of tagging of systems management resources, and more specifically to a method and system of reverse search to get business impact of tagged resources.

2. Description of the Related Art

Currently, to get an impression about dependencies and business impact of specific resources, only a best guess could be made. Such dependency can be documented, but it is very difficult to stay up to date since the environment is changing very fast. The documentation must be updated each time something is changed. A second problem is that it is hard to discover all dependencies of a specific resource, even sometimes it is unknown.

Often it is not clear what does it mean if a particular resource fails. In productive systems, it is not possible to test the resource since there are many dependencies to other components and resources and result may be too unpredictable. Therefore, it is beneficial to get an impression about the consequences to do a better planning and to implement high-availability concepts.

### SUMMARY OF THE INVENTION

In view of the foregoing and other exemplary problems, drawbacks, and disadvantages of the conventional methods and structures, an exemplary feature of the present invention is to provide a method of reverse search to get business impact of tagged resources.

An exemplary embodiment of the present invention includes a method of tagging systems management resources to visualize components which are related to an event.

The method includes automatically creating initial tags for information technology (IT) resources in an enterprise system or data center based on usage or access information, specifying in a user interface a specific resource in a tag cloud to search, using the resource to provide a reverse search of initiators of the resource to obtain business impact of the resource, and automatically presenting search results of the initiators in a new tag cloud in ranking order representing an amount of the usage or access information.

In this exemplary embodiment, the business impact is of interest. Accordingly, an operator can get important information about the IT business environment such as:
what does it mean when a special component fails;
what does it mean when a special component is shutdown;
which resources should be made redundant, because they have a big business impact; and
which business processes are impacted by a specified component (tag).

### BRIEF DESCRIPTION OF THE DRAWINGS

The foregoing and other exemplary purposes, aspects and advantages will be better understood from the following detailed description of exemplary embodiments of the invention with reference to the drawings, in which:

FIG. 1A illustrates a display of a tag cloud according to an exemplary aspect of the present invention;

FIG. 1B illustrates a display of a stored list according to an exemplary aspect of the present invention;

FIG. 2 illustrates a flow chart 200 of a method of tagging of systems management resources to visualize components which are related to an event according to an exemplary aspect of the present invention;

FIG. 3 illustrates a system 300 of tagging of systems management resources to visualize components which are related to an event according to an exemplary aspect of the present invention;

FIG. 4 illustrates an exemplary hardware/information handling system 400 for incorporating the present invention therein; and

FIG. 5 illustrates a signal bearing medium 500 (e.g., storage medium) for storing steps of a program of a method according to the present invention.

### DETAILED DESCRIPTION OF EXEMPLARY EMBODIMENTS OF THE INVENTION

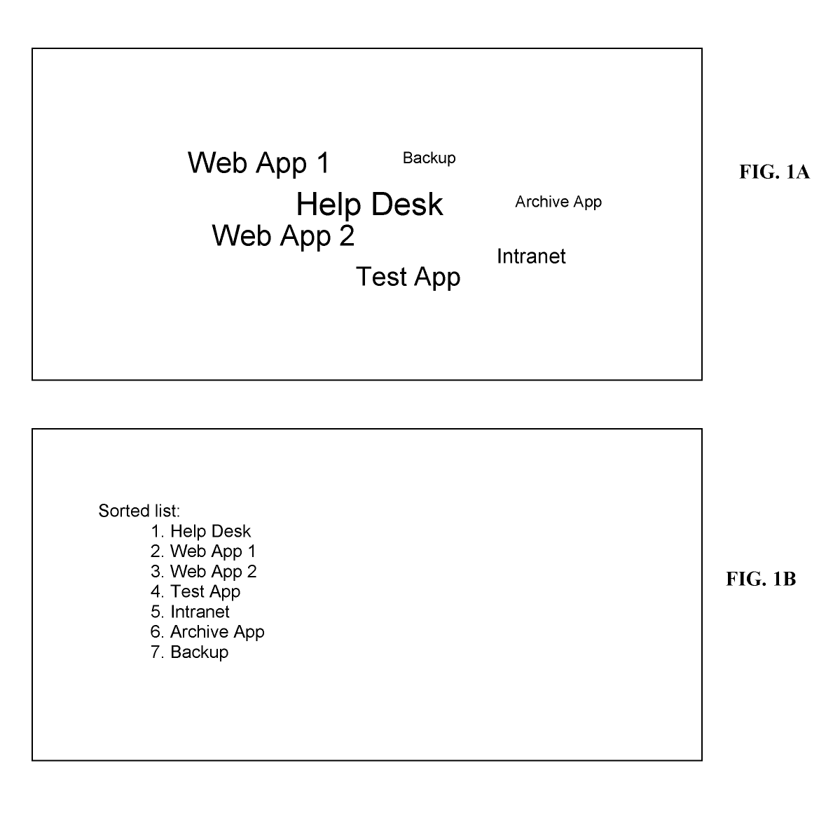

Referring now to the drawings, and more particularly to FIGS. 1-5, there are shown exemplary embodiments of the system and method according to the present invention.

The present invention applies tag clouds to systems management resources (i.e., to use “tagging”) to visualize components which are related to an event. Applications or business processes can also tag needed or used resources.

In an exemplary embodiment of the present invention a search engine is introduced to search for associations of applications with a particular tag, which is based on a reverse concept. A tag could be specified and the search engine searches for applications and business processes which has tagged this resource. The ranking of the results could be dependent on a number of times that the resource was tagged by an application.

FIG. 1A show display of a tag cloud according to an exemplary aspect of the present invention, in which a tag has been specified as the resource for a search engine.

Similarly, FIG. 1B illustrates a display of a stored list according to an exemplary aspect of the present invention, in which a tag has been specified as the resource for the search engine.

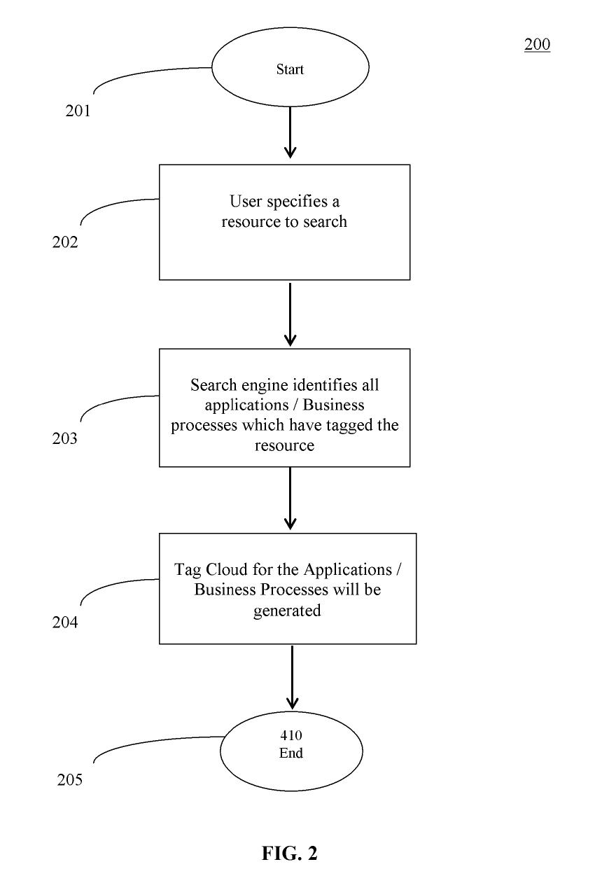

The reason for the manner that search results are displayed in FIGS. 1A and 2B is that “Help Desk”, “Web App 1” and “Web App 2” are running on the specified tag and are mostly affected. “Test App” needs just a connection to the specified tag and therefore partially is affected, and so on.

FIG. 2 shows a flow chart 200 of a method of tagging of systems management resources to visualize components which are related to an event according to an exemplary aspect of the present invention.

The method 200 starts in step 201, in which initial tags for IT resources in an enterprise system or data center based on usage or access information are automatically created. In step 202, a user specifies, in a user interface, a specific resource in a tag cloud to search. In step 203, a search engine reverses searches of initiators of the resource for all applications and business processes which have tagged the resource. The search results of the applications or business processes will be ranked depending on how many times they have tagged the specified resource. In step 204, results are automatically displayed by using a new tag cloud representing a ranking order of an amount of the usage or access information.

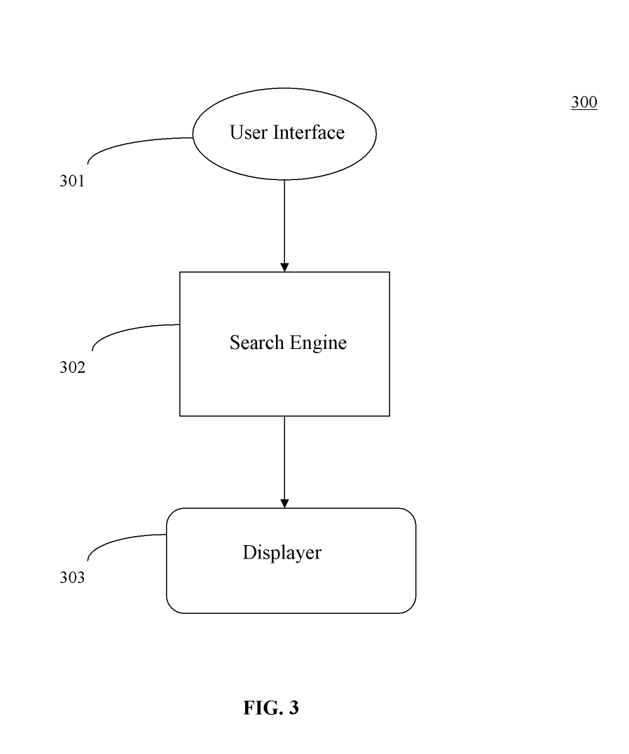

FIG. 3 depicts a system 300 for applying tag clouds to systems management to visualize components which are related to an event according to an exemplary aspect of the present invention. In system 300, a user specifies in a user interface 301 a specific resource in a tag cloud to search. Then, a search engine 301 is introduced. The user can search for specified tags/resources.

Search result deliver the information which applications/business processes are dependant on the tag/resource depending on a number of times that the resource was tagged by an application and are displayed in a displayer 303.

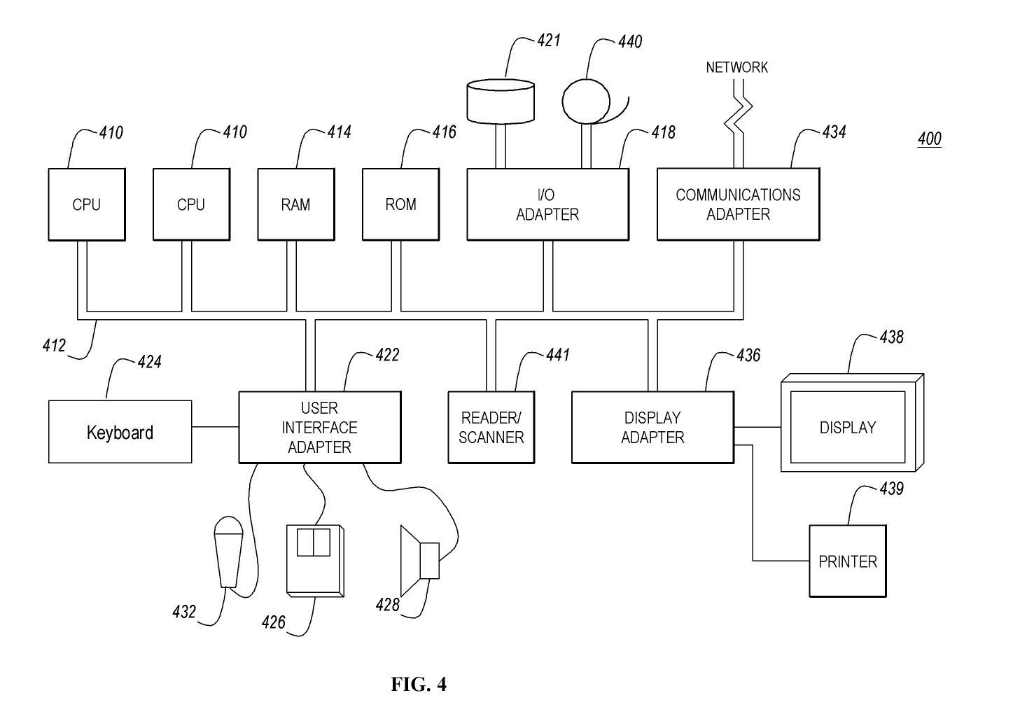

FIG. 4 illustrates a typical hardware configuration of an information handling/computer system for use with the invention and which preferably has at least one processor or central processing unit (CPU) 411.

The CPUs 411 are interconnected via a system bus 412 to a random access memory (RAM) 414, read only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting an information handling system to a data processing network, the Internet, an Intranet, a personal area network (PAN), etc., reader/scanner 441, and a display adapter 436 for connecting the bus 412 to a display device 438 and/or printer 440.

In addition to the hardware/software environment described above, a different aspect of the invention includes a computer implemented method for performing the above-described method. As an example, this method may be implemented in the particular environment discussed above.

Such a method may be implemented, for example, by operating a computer, as embodied by a digital data processing apparatus, to execute a sequence of machine readable instructions. These instructions may reside in various types of signal bearing media.

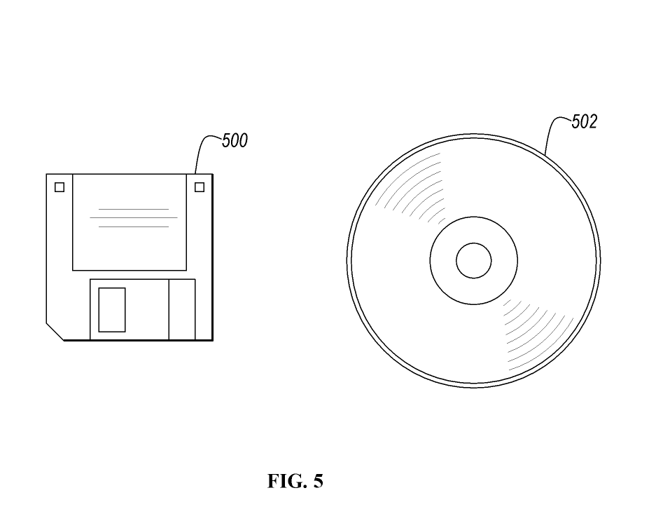

This signal bearing media may include, for example, a RAM contained within the CPU 411, as represented by the fast access storage for example. Alternatively, the instructions may be contained in another signal bearing media, such as a magnetic data storage diskette 500 (FIG. 5), directly or indirectly accessible by the CPU 411.

Whether contained in the diskette 500, the computer/CPU 411, or elsewhere, the instructions may be stored on a variety of machine readable data storage media, such as DASD storage (e.g., a conventional “hard drive” or a RAID array), magnetic tape, electronic read only memory (e.g., ROM, EPROM, or EEPROM), an optical storage device (e.g. CD ROM, WORM, DVD, digital optical tape, etc.), paper “punch” cards. In an illustrative embodiment of the invention, the machine readable instructions may comprise software object code, compiled from a language such as “C”, etc.

FIG. 5 illustrates a signal bearing medium 500 (e.g., storage medium) and CD ROM 502 for storing steps of a program of a method according present invention.

It should be noted that other purposes, features, and aspects of the present invention will become apparent in the entire disclosure. Modifications may be done without departing from the gist and scope of the present invention as disclosed herein and claimed as appended herewith.

In addition, it should be noted that any combination of the disclosed and/or claimed elements, matters and/or items may fall under the modifications aforementioned.

1. A method of applying a tag cloud to systems management resources to visualize components which are related to an event, said method comprising:
automatically creating initial tags for information technology (IT) resources, as executed by a processing unit on a computer, in an enterprise system or data center based on usage or access information;
specifying, in a user interface, a specific resource in the tag cloud to search;
using the resource to provide a reverse search of initiators of the resource to obtain business impact of the resource; and
automatically presenting search results of said initiators in a new tag cloud in a ranking order representing an amount of said usage or access information.
